(19) United States
(12) Patent Application Publication
(10) Pub. No.: US 2014/0009666 A1
(43) Pub. Date: Jan. 9, 2014

(54) IMAGE CAPTURING APPARATUS

(71) Applicant: Hideyuki Hamano, Kawasaki-shi (JP)

(72) Inventor: Hideyuki Hamano, Kawasaki-shi (JP)

(73) Assignee: CANON KABUSHIKI KAISHA, Tokyo (JP)

(21) Appl. No.: 14/005,871

(22) PCT Filed: Mar. 13, 2012
(86) PCT No.: PCT/JP2012/056950

§ 371 Date: Sep. 18, 2013

(30) Foreign Application Priority Data
Mar. 30, 2011 (JP) 2011-076393

(51) Int. Cl. G03B 13/36

(52) U.S. Cl. CPC G03B 13/36
USPC 348/353

(57) ABSTRACT

An image capturing apparatus obtains the ratio of light quantities of predetermined wavelengths contained in a light beam having passed through a focus detection region where focus detection is to be performed. When the light beam is eclipsed due to the imaging optical system, the image capturing apparatus obtains new correction coefficients obtained by calculating, in accordance with the ratio, eclipse correction coefficients determined in advance for the respective predetermined wavelengths. Then, the image capturing apparatus corrects outputs respectively from the pair of light receiving element arrays using the new correction coefficients, and performs focus detection using the corrected outputs from the pair of light receiving element arrays.

### TECHNICAL FIELD

The present invention relates to a technique of reducing the influence of an eclipse of a light beam arising from the structures of an imaging optical system and image capturing apparatus in focus detection.

### BACKGROUND ART

Some image capturing apparatuses such as a digital camera have a function of automatically adjusting an optical system including an imaging lens and focus lens in accordance with a imaging scene. Automatic adjustment functions are, for example, an autofocus function of detecting and controlling an in-focus position, and an exposure control function of performing photometry for an object to adjust the exposure to a correct one. By measuring the state of an object image, imaging settings suited to a imaging scene can be automatically selected, reducing the burden of settings on the user.

Focus detection methods adopted in the autofocus function are classified into an active method and passive method. In the active method, the distance to an object is measured using, for example, an ultrasonic sensor or infrared sensor, and the in-focus position is calculated in accordance with the distance and the optical characteristics of the optical system. The passive method includes a contrast detection method of detecting an in-focus position by actually driving the focus lens, and a phase difference detection method of detecting the phase difference between two pupil-divided optical images. Most image capturing apparatuses such as a digital single-lens reflex camera employ the latter method. A defocus amount representing the phase difference between two optical images is calculated, and the optical system is controlled to eliminate the defocus amount, thereby focusing on an object.

When performing the passive focus detection, two optical images to be compared need to have the same shape with merely a shift in the horizontal or vertical direction. However, a so-called “eclipse” may occur to cut off part of a light beam used in focus detection due to the lens or aperture of the optical system, the structure of the image capturing apparatus, or the like. If a light beam used in focus detection is eclipsed, the shape or luminance of an optical image used in focus detection changes. For this reason, neither the phase difference between pupil-divided optical images nor the contrast may be detected, or the precision may decrease.

To prevent generation of an eclipse, some image capturing apparatuses which execute the passive focus detection function restrict the aperture ratio of the imaging optical system or the focus detectable region. However, the following problems arise when the focus detection unit is designed not to eclipse a light beam used in focus detection. For example, when a line CCD used in focus detection is arranged so that a light beam which reaches the line CCD is not cut off by the openings of the apertures of various imaging lenses mounted on the image capturing apparatus, it is necessary to decrease the image height of the focus detectable region or reduce the line CCD scale. That is, the design not to eclipse a light beam used in focus detection narrows the focus detection range, decreases the focus detection precision due to shortage of the base-line length, or decreases the precision of focus detection for a low-luminance object.

However, some image capturing apparatuses improve the focus detection precision or widen the focus detection range by permitting an eclipse of a light beam used in focus detection and concretely grasping the eclipse generation conditions and the degree of eclipse. For example, there is an image capturing apparatus using a method of grasping a focus detection region where an eclipse occurs in accordance with the settings of the imaging optical system, and inhibiting focus detection in this focus detection region. Also, there is an image capturing apparatus using a method of mathematizing in advance attenuation of the light quantity of an optical image upon an eclipse, and correcting the output.

Japanese Patent Laid-Open No. 63-204236 discloses a technique of numerically expressing the amount of eclipse (eclipse amount) of a light beam. In this technique, the reliability of a defocus amount calculated by focus detection is determined based on whether the eclipse amount exceeds a predetermined threshold which changes dynamically based on the presence/absence of an eclipse.

In general, the optical system such as the imaging lens has so-called chromatic aberration in which the refractive index changes for each light wavelength contained in a light beam. More specifically, a light beam having passed through the lens is split into light components of respective wavelengths. An optical image used in focus detection has different optical paths extending to the imaging surface of the optical image for the respective wavelengths. Thus, the presence/absence of an eclipse, the eclipse amount, and the like differ between the respective wavelengths. However, Japanese Patent Laid-Open No. 63-204236 does not consider the chromatic aberration of the imaging optical system, so an error may occur depending on the spectral intensity in focus detection.

Chromatic aberration can be reduced using a plurality of optical components. However, this is not practical considering the difficulty of completely eliminating chromatic aberration, an increase in space for arranging the optical components, the manufacturing cost of the optical components, and the like.

### SUMMARY OF INVENTION

The present invention has been made to solve the conventional problems. The present invention provides improvement of the precision of focus detection considering an eclipse arising from chromatic aberration.

According to one aspect of the present invention, there is provided an image capturing apparatus including detection means for performing passive focus detection using outputs from a pair of light receiving element arrays which receive optical images generated by a pair of light beams having passed through different regions of an exit pupil of an imaging optical system, comprising: obtaining means for obtaining a ratio of light quantities of predetermined wavelengths contained in a light beam having passed through a focus detection region where focus detection is to be performed by the detection means; determination means for determining whether the light beam is eclipsed due to the imaging optical system; and correction means for, when the determination means determines that the light beam is eclipsed, correcting outputs respectively from the pair of light receiving element arrays using new correction coefficients obtained by calculating, in accordance with the ratio, eclipse correction coefficients determined in advance for the respective predetermined wavelengths, wherein when the determination means determines that the light beam is eclipsed, the detection means performs the focus detection using the outputs from the pair of light receiving element arrays that have been corrected by the correction means.

According to another aspect of the present invention, there is provided a method of controlling an image capturing apparatus including detection means for performing passive focus detection using outputs from a pair of light receiving element arrays which receive optical images generated by a pair of light beams having passed through different regions of an exit pupil of an imaging optical system, comprising: an obtaining step of obtaining a ratio of light quantities of predetermined wavelengths contained in a light beam having passed through a focus detection region where focus detection is to be performed by the detection means; a determination step of determining whether the light beam is eclipsed due to the imaging optical system; and a correction step of correcting outputs respectively from the pair of light receiving element arrays using new correction coefficients obtained by calculating, in accordance with the ratio, eclipse correction coefficients determined in advance for the respective predetermined wavelengths when the light beam is determined in the determination step to be eclipsed, wherein when the light beam is determined in the determination step to be eclipsed, the detection means performs the focus detection using the outputs from the pair of light receiving element arrays that have been corrected in the correction step.

Further features of the present invention will become apparent from the following description of exemplary embodiments (with reference to the attached drawings).

### BRIEF DESCRIPTION OF DRAWINGS

FIG. 1 is a sectional view showing the arrangement of a digital camera 100 according to an embodiment of the present invention;

FIG. 2 is an exploded perspective view showing a focus detection unit 120 according to the embodiment of the present invention;

FIG. 3 is a plan view showing openings 211 of an aperture 204 of the focus detection unit 120 according to the embodiment of the present invention;

FIGS. 4A and 4B are plan views showing a secondary imaging lens unit 205 of the focus detection unit 120 according to the embodiment of the present invention;

FIG. 5 is a plan view showing light receiving element arrays 214 of a light receiving unit 206 of the focus detection unit 120 according to the embodiment of the present invention;

FIGS. 6A and 6B are views showing back-projection of the light receiving element arrays 214 on the surface of a field mask 201 of the focus detection unit 120 according to the embodiment of the present invention;

FIG. 7 is a top view showing a state in which an optical path extending to the focus detection unit 120 along the optical axis of an imaging optical system 101 is unfolded to be straight according to the embodiment of the present invention;

FIG. 8 is a view showing projection of respective members regarding a light beam on the surface of a imaging lens aperture 304 according to the embodiment of the present invention;

FIG. 9 is a top view showing another state in which an optical path extending to the focus detection unit 120 along the optical axis of the imaging optical system 101 is unfolded to be straight according to the embodiment of the present invention;

FIG. 10 is a view showing another projection of respective members regarding a light beam on the surface of the imaging lens aperture 304 according to the embodiment of the present invention;

FIGS. 11A and 11B are graphs showing the influence of an eclipse on an output from the light receiving element array 214 according to the embodiment of the present invention;

FIG. 12 is a top view showing still another state in which an optical path extending to the focus detection unit 120 along the optical axis of the imaging optical system 101 is unfolded to be straight according to the embodiment of the present invention;

FIGS. 13A and 13B are views showing still another projection of respective members regarding a light beam on the surface of the imaging lens aperture 304 according to the embodiment of the present invention;

FIG. 14 is a block diagram showing the circuit arrangement of the digital camera 100 according to the embodiment of the present invention;

FIG. 15 is a block diagram showing the internal arrangement of a photometry circuit 1407 according to the embodiment of the present invention;

FIG. 16 is a flowchart showing object focusing processing according to the embodiment of the present invention;

FIG. 17 is a table showing the presence/absence of generation of an eclipse according to the embodiment of the present invention; and

FIG. 18 is a table showing a correction coefficient for correcting an output from the light receiving element array 214 under a focus detection condition according to the embodiment of the present invention.

### DESCRIPTION OF EMBODIMENTS

Preferred embodiments of the present invention will now be described in detail with reference to the accompanying drawings. In the following embodiment, the present invention is applied to a digital camera having the phase difference detection type focus detection function as an example of an image capturing apparatus. However, the present invention is applicable to an arbitrary device having the passive focus detection function.

(Arrangement of Digital Camera 100)

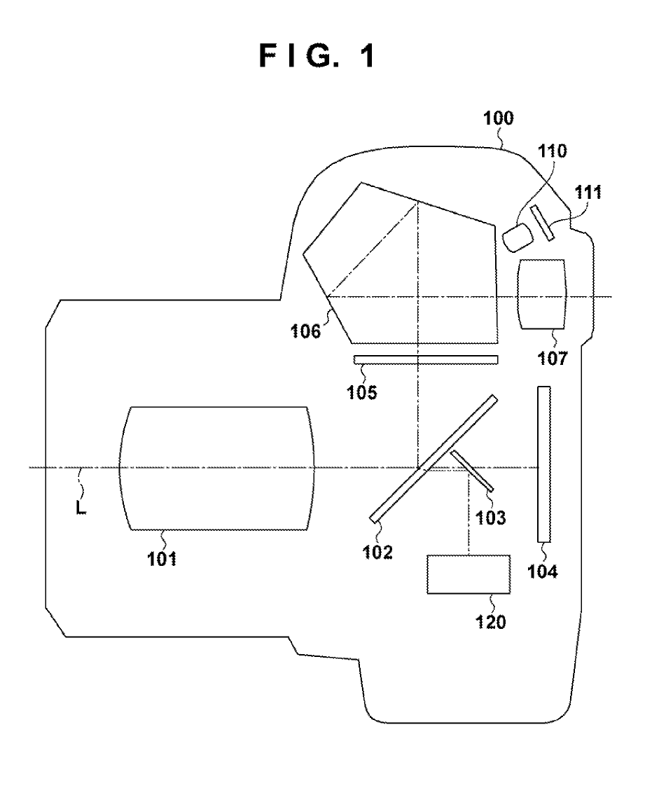

FIG. 1 is a center sectional view showing a lens-interchangeable single-lens reflex digital camera 100 according to the embodiment of the present invention.

An imaging optical system 101 is a lens unit including a imaging lens and focus lens. The lens unit is centered on an optical axis L of the imaging optical system 101 shown in FIG. 1. An image sensor unit 104 including an optical low-pass filter, infrared cut filter, and image sensor is arranged near the expected imaging surface of the imaging optical system 101.

A main mirror 102 and sub-mirror 103 are interposed between the imaging optical system 101 and the image sensor unit 104 on the optical axis, and are retracted from the optical path of a imaging light beam by a well-known quick return mechanism in imaging. The main mirror 102 is a half mirror, and splits the imaging light beam into reflected light which is guided to a viewfinder optical system above the main mirror 102, and transmitted light which impinges on the sub-mirror 103.

Light reflected by the main mirror 102 forms an image on the matt surface of a focusing plate 105 having the matt surface and Fresnel surface. The image is guided to the observer eye via a pentaprism 106 and eyepiece lens unit 107. Part of light diffused by the focusing plate 105 passes through a photometry lens 110 and reaches a photometry sensor 111. The photometry sensor 111 is formed from a plurality of pixels, and R, G, and B color filters are arranged on the respective pixels so that the spectral intensity of an object can be detected. In the embodiment, the photometry sensor 111 includes R, G, and B color filters. However, the practice of the present invention is not limited to this embodiment as long as the photometry sensor 111 includes color filters having predetermined wavelengths as center wavelengths of transmitted light.

The optical path of transmitted light having passed through the main mirror 102 is deflected downward by the sub-mirror 103, and guided to a focus detection unit 120. More specifically, part of a light beam having passed through the imaging optical system 101 is reflected by the main mirror 102 and reaches the photometry sensor 111, and the remaining light beam passes through the main mirror 102 and reaches the focus detection unit 120. The focus detection unit 120 detects the focal length by the phase difference detection method. Note that spectral reflectance information of the main mirror 102 may be stored in advance in a nonvolatile memory (not shown). In this case, the spectral intensity of a light beam which reaches the focus detection unit 120 can be detected using an output from the photometry sensor 111.

(Arrangement of Focus Detection Unit 120)

An example of the internal arrangement of the focus detection unit 120 will be explained in detail with reference to the accompanying drawings.

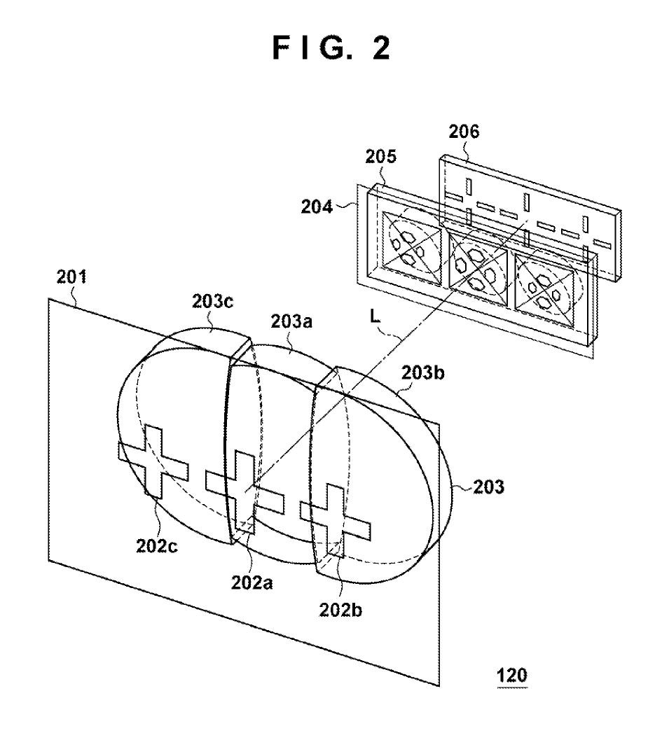

FIG. 2 is a perspective view schematically showing the structure of the focus detection unit 120. In practice, the focus detection unit 120 saves the space by deflecting the optical path using a reflecting mirror or the like. However, in FIG. 2, the reflecting mirror or the like on the optical path is omitted, and the optical path is unfolded to be straight for descriptive convenience.

A field mask 201 is a mask for preventing entrance of disturbance light into light receiving element arrays 214 (to be described later) which perform focus detection. The field mask 201 is arranged near a position optically equivalent via the sub-mirror 103 to the imaging surface of the image sensor unit 104 serving as the expected imaging surface of the imaging optical system 101. In the embodiment, the field mask 201 has three cross-shaped openings 202 as shown in FIG. 2. Of light beams which have reached the focus detection unit 120, only light beams having passed through the cross-shaped openings are used for focus detection.

In the description of the embodiment, the three cross-shaped openings 202 are identified by assigning a to the cross-shaped opening positioned at the center, b to the cross-shaped opening positioned right, and c to the cross-shaped opening positioned left in the arrangement of FIG. 2. Even members which follow the field mask 201 and form the focus detection unit 120 are identified by assigning the same symbols as those of the cross-shaped openings which transmit light beams reaching these members. Assume that the optical axis of the imaging optical system 101 extends through the center of the cross-shaped opening 202a.

A field lens 203 includes field lenses 203a, 203b, and 203c having different optical characteristics. The respective lenses have optical axes different from each other.

Light beams having passed through the field lenses 203a, 203b, and 203c pass through corresponding openings of an aperture 204, and then reach a secondary imaging lens unit 205. Note that an infrared cut filter is arranged in front of the aperture 204 to remove, from the light beam, a component of an infrared wavelength unnecessary for focus detection, but is not illustrated for simplicity.

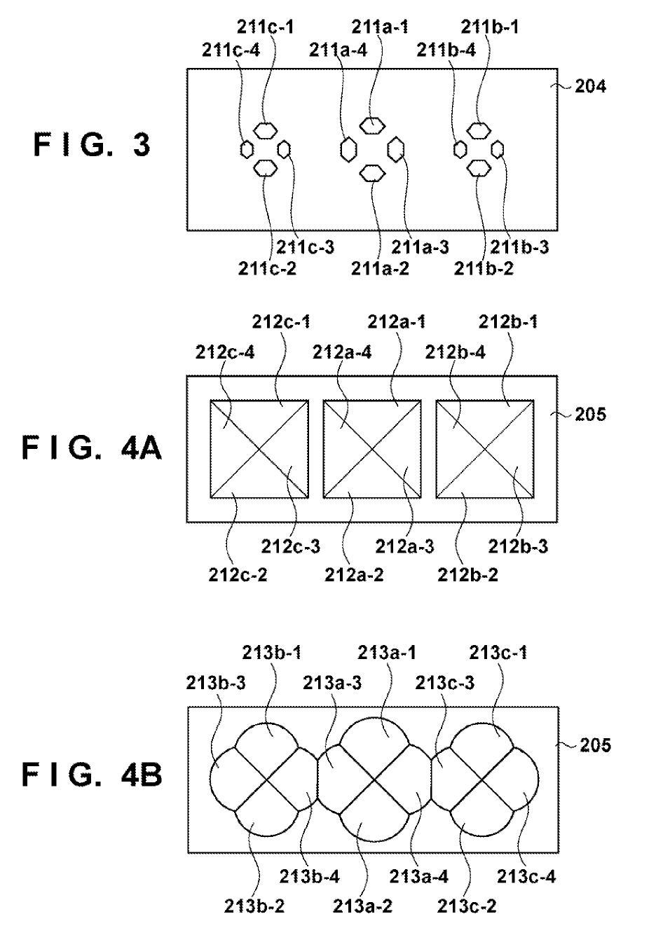

As shown in FIG. 3, the aperture 204 has openings 211a, 211b, and 211c which transmit light beams having passed through the cross-shaped openings 202a, 202b, and 202c, respectively. In the embodiment, each opening has pairs of openings in the vertical and horizontal directions, that is, a total of four openings. In the description of the embodiment, the respective openings are identified by assigning 1 to an upper opening in the vertical direction, 2 to a lower opening, 3 to a right opening in the horizontal direction, and 4 to a left opening in the arrangement of FIG. 3. More specifically, a light beam having passed through the cross-shaped opening 202c passes through the openings 211c-1, 211c-2, 211c-3, and 211c-4 of the aperture 204. Even members which follow the aperture 204 and form the focus detection unit 120 are identified by assigning the same numerals as those of the openings which transmit light beams reaching these members.

The secondary imaging lens unit 205 forms again, on a light receiving unit 206 arranged behind, images having passed through the cross-shaped openings 202 out of an optical image which is formed on the field mask 201 corresponding to the expected imaging surface via the sub-mirror 103 by the imaging optical system 101. The secondary imaging lens unit 205 includes prisms 212 as shown in FIG. 4A and spherical lenses 213 as shown in FIG. 4B.

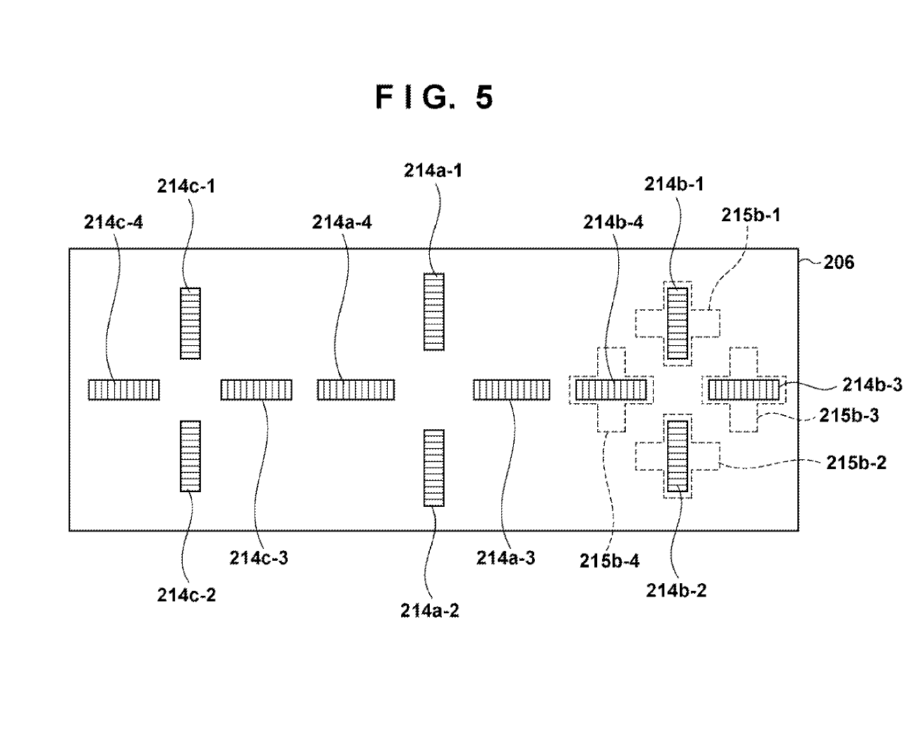

The light receiving unit 206 includes a pair of light receiving element arrays 214 which are arranged in each of the vertical and horizontal directions for each of the cross-shaped openings 202a, 202b, and 202c, as shown in FIG. 5. Each light receiving element array is, for example, an optical element such as a line CCD. Light beams having passed through different regions of the exit pupil, that is, cross-shaped optical images having passed through the corresponding cross-shaped openings 202 form images on the respective light receiving element arrays.

The distance between optical images formed on the light receiving element arrays paired in the vertical or horizontal direction changes depending on the focus state of an optical image formed on the expected imaging surface of the imaging optical system 101. A defocus amount representing the focus state is calculated based on the difference (change amount) between the distance between optical images that is obtained by calculating the correlation between the light quantity distributions of optical images output from the paired light receiving element arrays 214, and a predetermined distance between in-focus optical images. More specifically, the relationship between the defocus amount and the distance change amount is approximated in advance using a polynomial for the distance change amount. The defocus amount is calculated using the change amount of the distance between optical images that is obtained by the focus detection unit 120. A focus position where an object is in focus can be obtained from the calculated defocus amount. The focus lens is controlled by a focus lens driving unit (not shown), thereby focusing on the object.

Note that the light receiving element arrays paired in one direction are suited to focus detection of an object image having the contrast component in this direction. By arranging the light receiving element arrays 214 in the vertical and horizontal directions as in the embodiment, so-called cross-shaped focus detection can be executed regardless of the direction of the contrast component of an object image.

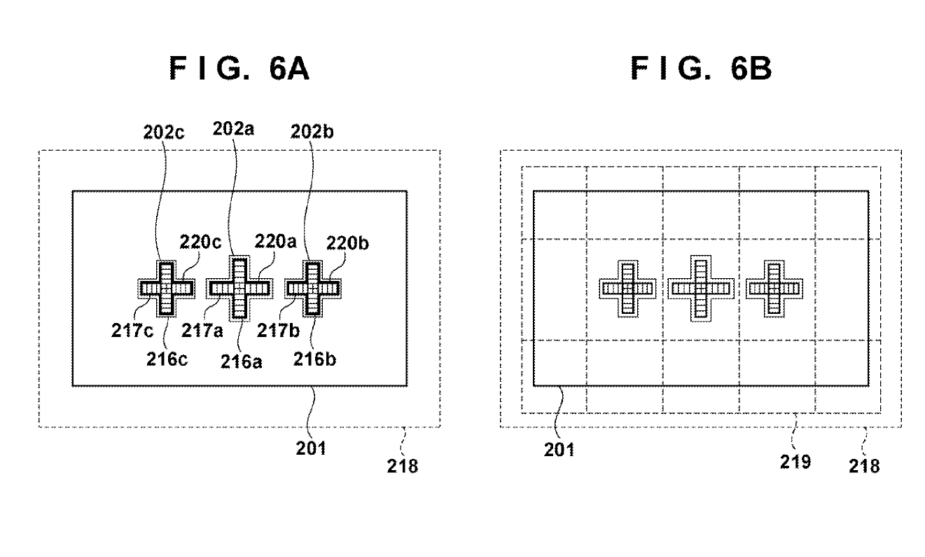

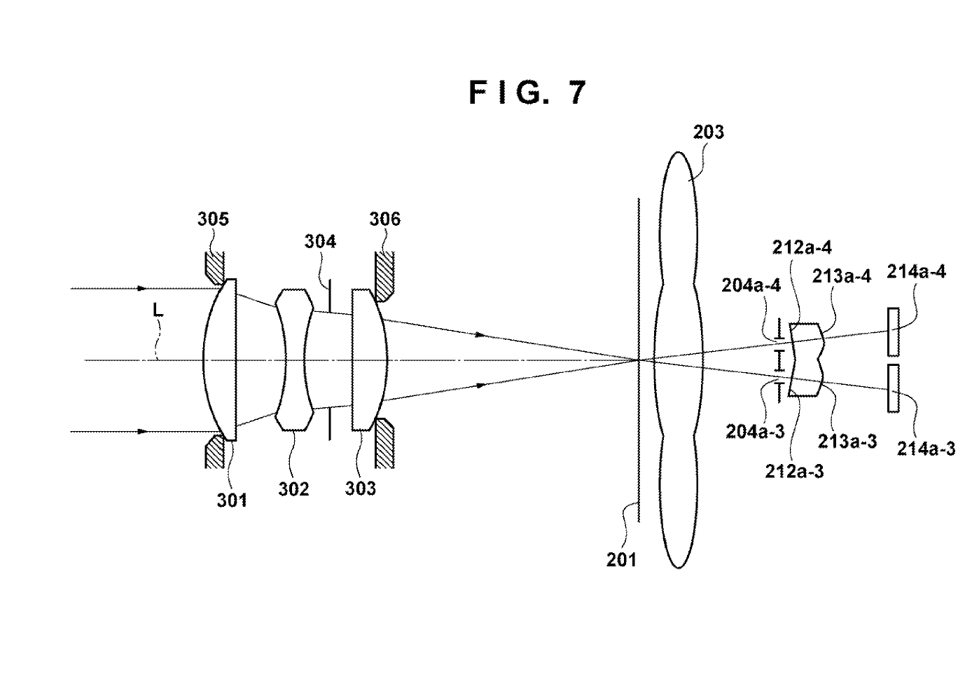

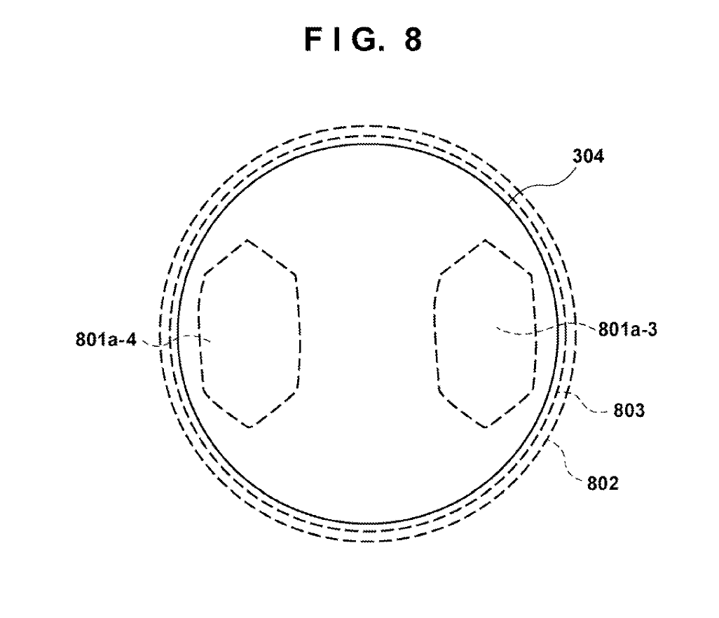

FIG. 6A shows back-projection of the light receiving element arrays 214 on the surface of the field mask 201 of the focus detection unit 120 that is arranged near a position optically equivalent to the expected imaging surface of the imaging optical system 101. In the description of the embodiment, the surface of the field mask 201 is equivalent to the expected imaging surface, and will be referred to as the expected imaging surface.

As shown in FIG. 6A, the light receiving element arrays 214 paired in the vertical direction and the light receiving element arrays 214 paired in the horizontal direction form one back-projected image 216 and one back-projected image 217 on the expected imaging surface, respectively. More specifically, so-called cross-shaped focus detection regions 220 are defined by back-projected image regions respectively formed from back-projected images 216a, 216b, and 216c and back-projected images 217a, 217b, and 217c within the regions of the cross-shaped openings 202a, 202b, and 202c within a imaging range 218.

The embodiment assumes that the photometry sensor 111 performs photometry for 15 photometry regions obtained by dividing a photometry range 219 into three in the vertical direction and five in the horizontal direction. The photometry range 219 and the focus detection regions 220 of the focus detection unit 120 have a positional relationship as shown in FIG. 6B. Each focus detection region 220 corresponds to one photometry region. The photometry sensor 111 can detect the spectral intensity of a light beam having passed through the focus detection region 220.

(Principle of Eclipse in Focus Detection)

The relationship between a light beam which reaches the light receiving unit 206 of the focus detection unit 120 and a light beam which passes through the imaging optical system 101 when performing focus detection in the focus detection region 220a will be explained with reference to FIG. 7.

FIG. 7 is a top view showing a state in which an optical path extending to the focus detection unit 120 along the optical axis of the imaging optical system 101 is unfolded to be straight. FIG. 7 shows, of light beams passing through the imaging optical system 101, light beams passing through the point of intersection between the field mask 201 and the optical axis L. FIG. 7 shows only members paired in the horizontal direction out of the openings 211a of the aperture 204, the prisms 212a and spherical lenses 213a of the secondary imaging lens unit 205, and the light receiving element arrays 214a of the light receiving unit 206 through which the light beams pass.

As shown in FIG. 7, the imaging optical system 101 is formed from lenses 301, 302, and 303, a imaging lens aperture 304 which adjusts the diameter of a light beam passing through the imaging optical system 101, and a front frame member 305 and back frame member 306 which hold the imaging optical system 101.

As described above, light beams passing through the point of intersection between the field mask 201 and the optical axis L are determined by the aperture diameter of the imaging lens aperture 304. Of these light beams, only light beams passing through a region obtained by back-projecting the openings 211a-3 and 211a-4 of the aperture 204 on the surface of the imaging lens aperture 304 via the field lens 203 reach the light receiving unit 206 of the focus detection unit 120.

More specifically, when viewed from the point of intersection between the field mask 201 and the optical axis L, the openings 211a-3 and 211a-4 back-projected on the surface of the imaging lens aperture 304 form back-projected images 801a-3 and 801a-4, as shown in FIG. 8. Of light beams in the aperture region of the imaging lens aperture 304, only light beams passing through the back-projected images 801a-3 and 801a-4 form images on the light receiving unit 206. As for light beams passing through the point of intersection between the field mask 201 and the optical axis L, light beams used in focus detection are not eclipsed as long as the back-projected images 801a-3 and 801a-4 fall within the aperture region of the imaging lens aperture 304.

Also, light beams passing through the point of intersection between the field mask 201 and the optical axis L are free from an eclipse caused by vignetting by the front frame member 305 and back frame member 306. As shown in FIG. 8, the front frame member 305 and back frame member 306 are projected on the surface of the imaging lens aperture 304, forming projected images 802 and 803. Light beams passing through the back-projected images 801a-3 and 801a-4 do not change in size, and vignetting by the projected images 802 and 803 outside the back-projected images 801a-3 and 801a-4 does not occur. As for light beams passing through the point of intersection between the field mask 201 and the optical axis L, the presence/absence of an eclipse is determined based on only the aperture diameter of the imaging lens aperture 304.

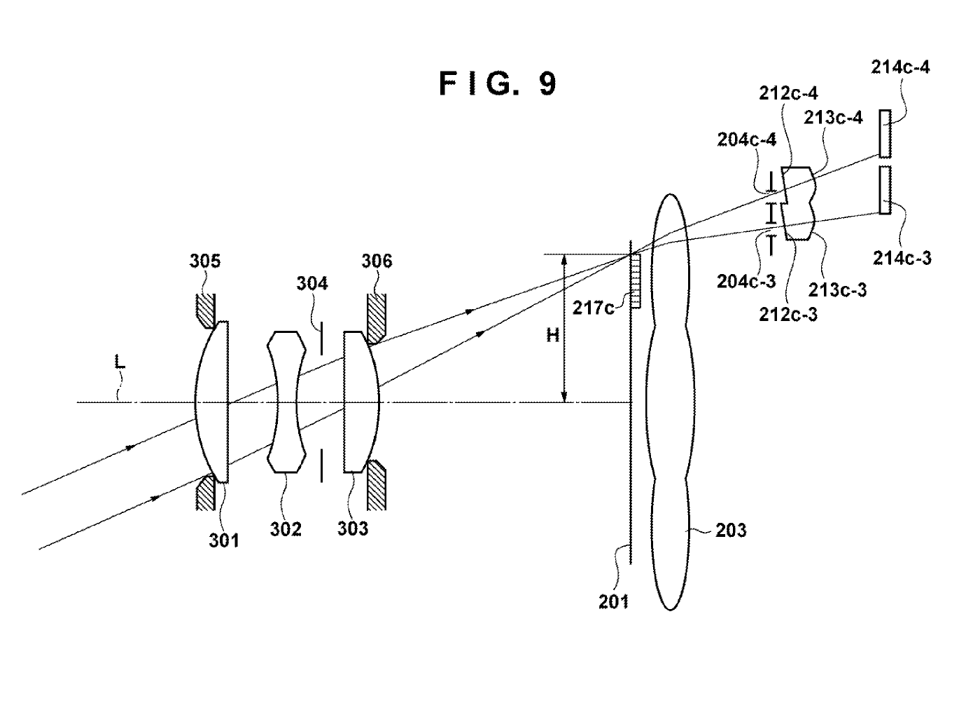

To the contrary, when focus detection is performed in the focus detection region 220c, the presence/absence of an eclipse of a light beam which reaches the light receiving unit 206 of the focus detection unit 120 is changes. This will be described with reference to the top view of FIG. 9.

FIG. 9 shows, of light beams passing through the imaging optical system 101, light beams passing through an end point on the side far from the optical axis L on the back-projected image 217c of the light receiving element arrays 214c-3 and 214c-4 on the surface of the field mask 201. Also, FIG. 9 shows only members paired in the horizontal direction out of the openings 211c of the aperture 204, the prisms 212c and spherical lenses 213c of the secondary imaging lens unit 205, and the light receiving element arrays 214c of the light receiving unit 206 through which the light beams pass. Note that H is the distance, that is, image height between the end point on the side far from the optical axis L on the back-projected image 217c and the optical axis L.

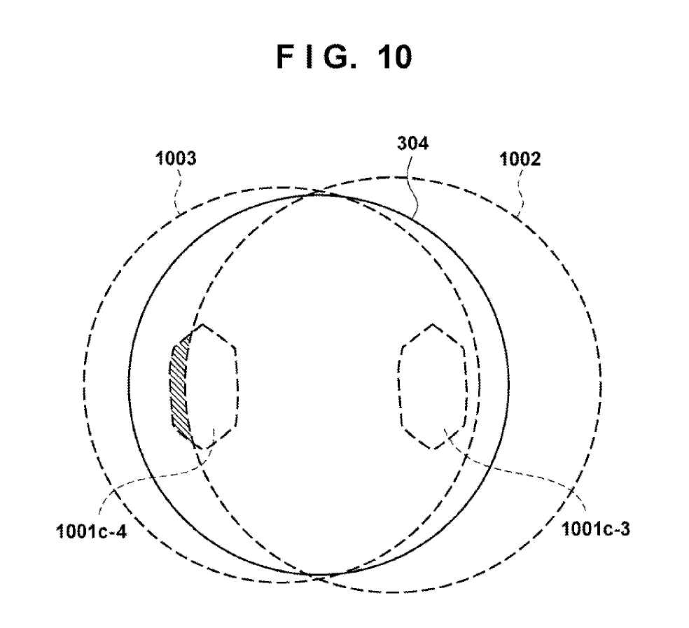

As shown in FIG. 9, light beams passing through the end point on the side far from the optical axis L on the back-projected image 217c are determined by the aperture diameter of the imaging lens aperture 304, the front frame member 305, and the back frame member 306. When viewed from the end point on the side far from the optical axis L on the back-projected image 217c, the front frame member 305 and back frame member 306 projected on the surface of the imaging lens aperture 304 form a projected image 1002 and projected image 1003, as shown in FIG. 10. In the positional relationship as shown in FIG. 10, a back-projected image 1001c-4 of the opening 211c-4 that is back-projected on the surface of the imaging lens aperture 304 is shielded by the projected image 1003 of the back frame member 306 (hatched portion in FIG. 10). Even when a light beam used in focus detection is not eclipsed by the imaging lens aperture 304, it is eclipsed due to vignetting by the front frame member 305 and back frame member 306.

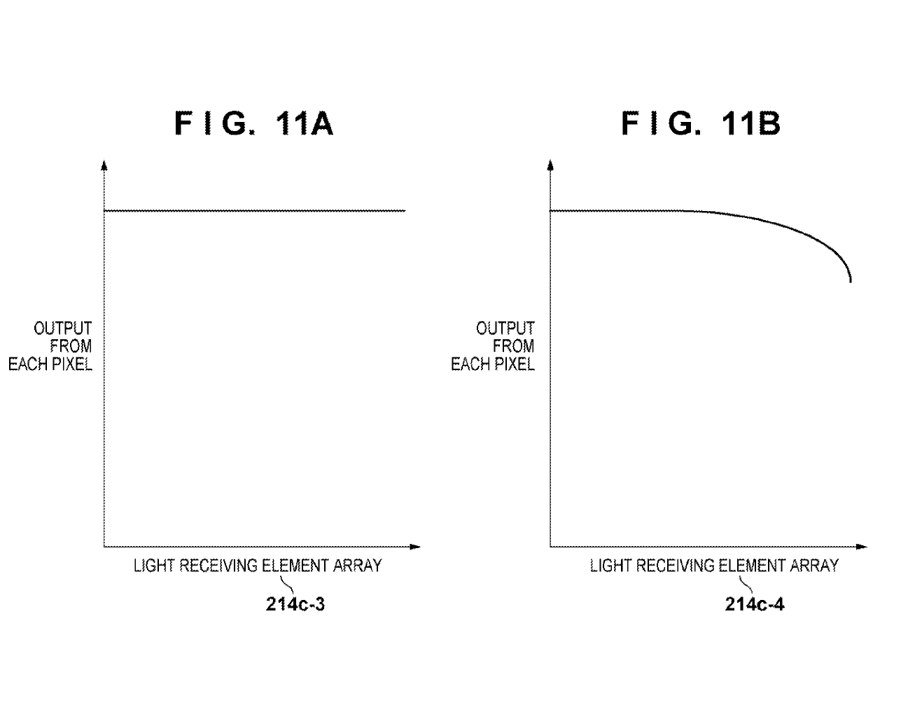

The generated eclipse results in a difference between outputs from the light receiving element arrays 214c-3 and 214c-4 corresponding to the focus detection region 220c. For example, for an object image exhibiting a uniform luminance, the respective light receiving element arrays exhibit outputs as shown in FIGS. 11A and 11B. An output from the light receiving element array 214c-4 corresponding to the back-projected image 1001c-4 suffering an eclipse decreases in a given region. In FIGS. 11A and 11B, the abscissa represents the image height of an object image, and the ordinate represents an output from each pixel of a line sensor serving as the light receiving element array in correspondence with the image height. As is apparent from FIG. 10, as the image height H of the focus detection region becomes smaller, the influence of an eclipse by vignetting of the imaging optical system 101 on a light beam used in focus detection becomes smaller.

Assume that an output from each light receiving element array 214 shown in FIG. 11 has already performed so-called shading correction. In general, even when the luminance of an object image is uniform, an output from the light receiving element array 214 does not become uniform due to limb darkening of the imaging optical system 101 and focus detection optical system, sensitivity variations of the pixels of the light receiving element array 214, and the like. As for the output nonuniformity, shading correction is generally executed using a correction amount which is stored in advance in a nonvolatile memory or the like and is set for an output from the light receiving element array 214 so that the output becomes uniform without any eclipse of a light beam by the imaging optical system 101.

(Difference in Eclipse Depending on Wavelength Difference)

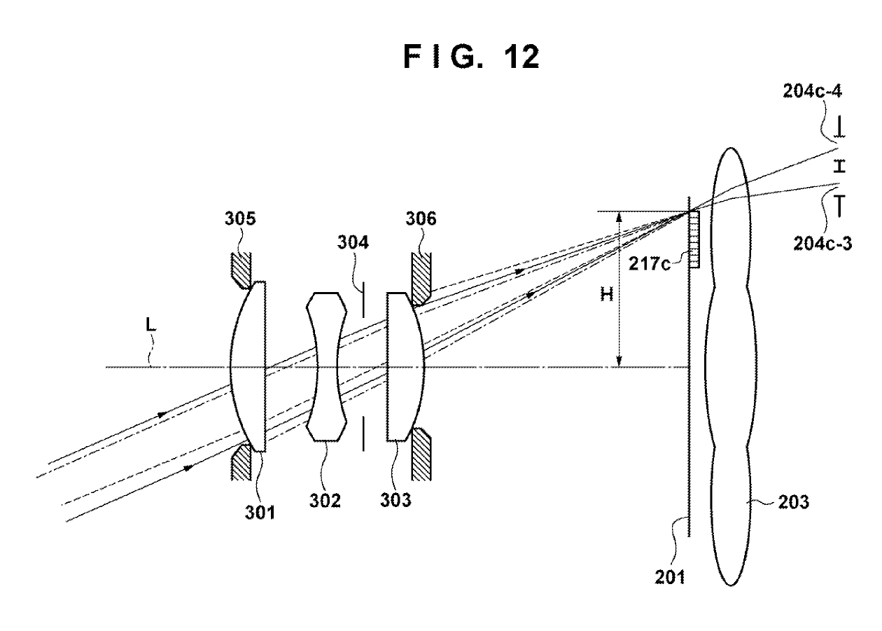

An object image is generally colored and contains light components of various wavelengths. In practice, a light beam having passed through the imaging optical system 101 and field lens 203 is split into light components of respective wavelengths, as described above. Splitting of a light beam passing through the end point on the side far from the optical axis L on the back-projected image 217 as in FIG. 9 will be explained with reference to FIG. 12. In general, the imaging optical system 101 is devised to reduce chromatic aberration by using a plurality of lenses. To the contrary, the field lens 203 is formed from a smaller number of (one in this embodiment) lenses, so a list beam is split for respective wavelengths.

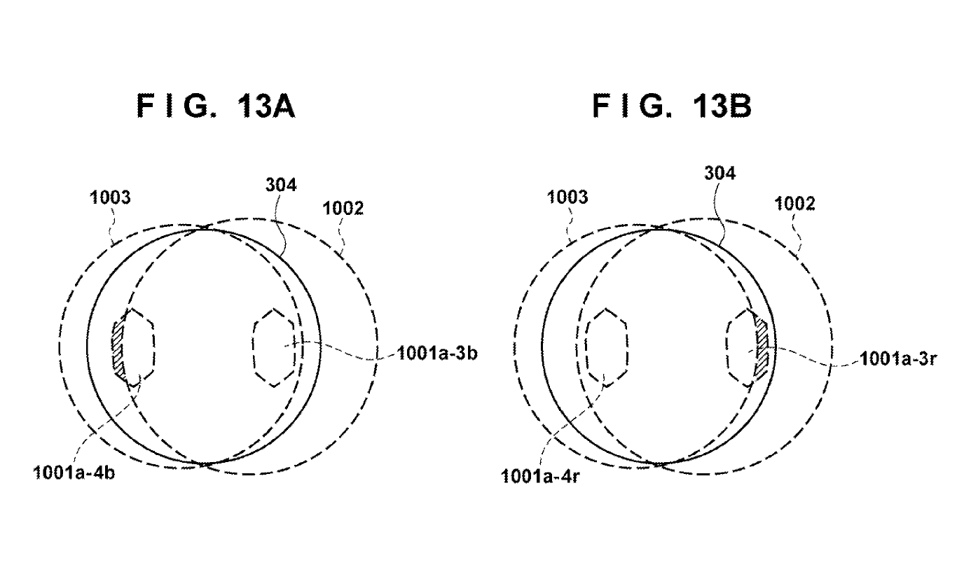

In FIG. 12, a chain line indicates a blue light component of a short wavelength in visible light of a light beam, and a broken line indicates a red light component of a long wavelength. As shown in FIG. 12, a light beam of the blue light component suffers vignetting by the front frame member 305. A light beam of the red light component suffers vignetting by the back frame member 306. In this case, when viewed from the end point on the side far from the optical axis L on the back-projected image 217c toward the centers of the light beams of the respective components, members back-projected or projected on the surface of the imaging lens aperture 304 are as shown in FIGS. 13A and 13B.

In FIG. 13A, when viewed toward the center of the light beam of the blue light component, a partial region of a back-projected image 1001a-4b of the light receiving element array 214a-4 that is back-projected on the surface of the imaging lens aperture 304 falls outside the projected image 1002 of the front frame member 305. As for the light beam of the blue light component, a light beam used in focus detection is eclipsed due to vignetting on the light receiving element array 214a-4.

In FIG. 13B, when viewed toward the center of the light beam of the red light component, a partial region of a back-projected image 1001a-3r of the light receiving element array 214a-3 that is back-projected on the surface of the imaging lens aperture 304 falls outside the projected image 1002 of the front frame member 305. That is, as for the light beam of the red light component, a light beam used in focus detection is eclipsed due to vignetting on the light receiving element array 214a-3. In FIG. 12, the front frame member 305 eclipses the blue light component of a light beam which reaches the light receiving element array 214a-4. The back frame member 306 eclipses the red light component of a light beam which reaches the light receiving element array 214a-3.

Which of light beams of the red and blue wavelengths is eclipsed out of a pair of light beams used in focus detection is determined based on the image height, the position of a member which causes an eclipse, and the opening size. As shown in FIG. 12, as a frame member having an opening of a given size moves apart from the field mask 201 along the optical axis L, the blue light component of a light beam which reaches the light receiving element array 214a-4 is readily eclipsed. In contrast, as a frame member having an opening of a given size moves close to the field mask 201 along the optical axis L, the red light component of a light beam which reaches the light receiving element array 214a-3 is readily eclipsed. From this, if the diameters of the imaging lens aperture 304, front frame member 305, and back frame member 306, their positions on the optical axis L, and the image height H are known, it is possible to calculate the diameters and decentering amounts of the front frame member 305 and back frame member 306 which are projected on the surface of the imaging lens aperture 304 as shown in FIGS. 13A and 13B. In other words, the positional relationship between the focus detection light beam position and each member on the surface of the imaging lens aperture 304 can be obtained, and the presence/absence and amount of an eclipse can be calculated.

In some cases, a light receiving element array suffering an eclipse changes depending on splitting of a light beam used in focus detection. The focus detection precision decreases if processing of correcting a luminance decrease caused by an eclipse is simply applied to an output from one of paired light receiving element arrays as shown in FIG. 9.

(Circuit Arrangement of Digital Camera 100)

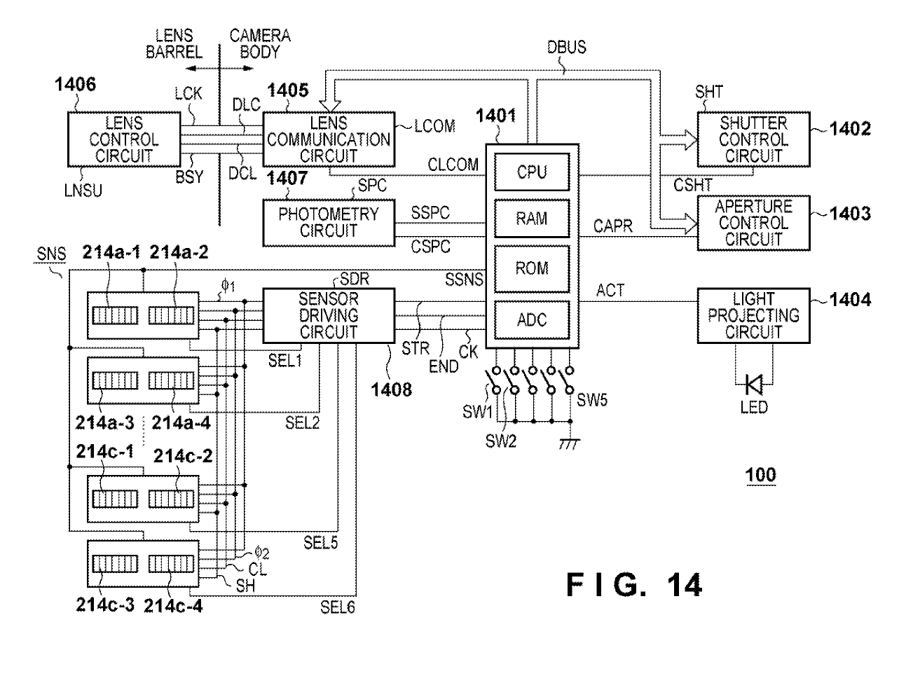

FIG. 14 is a block diagram showing the circuit arrangement of the digital camera 100 according to the embodiment of the present invention.

A central processing circuit 1401 is a 1-chip microcomputer including a CPU, RAM, ROM, ADC (A/D converter), and input/output ports. The ROM of the central processing circuit 1401 is a nonvolatile memory. The ROM stores control programs for the digital camera 100 including the program of object focusing processing (to be described later), and parameter information about settings of the digital camera 100 and the like. In the embodiment, the ROM stores even information about the state of the imaging optical system 101 for determining whether a light beam used in focus detection is eclipsed.

A shutter control circuit 1402 controls traveling of the front and rear curtains of a shutter (not shown) based on information input via a data bus DBUS while receiving a control signal CSHT from the central processing circuit 1401. More specifically, the central processing circuit 1401 receives SW2 corresponding to a release button imaging instruction from SWS which outputs a switching signal upon operating the user interface of the digital camera 100. Then, the central processing circuit 1401 outputs a control signal to drive the shutter.

An aperture control circuit 1403 controls driving of the imaging lens aperture 304 by controlling an aperture driving mechanism (not shown) based on information input via the DBUS while receiving a control signal CAPR from the central processing circuit 1401.

A light projecting circuit 1404 projects auxiliary light for focus detection. The LED of the light projecting circuit 1404 emits light in accordance with a control signal ACT and sync clock CK from the central processing circuit 1401.

A lens communication circuit 1405 serially communicates with a lens control circuit 1406 based on information input via the DBUS while receiving a control signal CLCOM from the central processing circuit 1401. The lens communication circuit 1405 outputs lens driving data DCL for the lens of the imaging optical system 101 to the lens control circuit 1406 in synchronism with a clock signal LCK. In addition, the lens communication circuit 1405 receives lens information DLC representing the lens state. The lens driving data DCL contains the body type of the digital camera 100 on which the imaging optical system 101 is mounted, the type of the focus detection unit 120, and the lens driving amount.

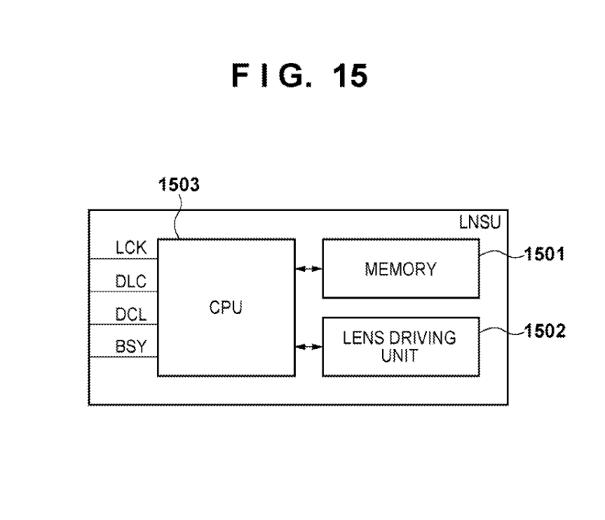

The lens control circuit 1406 changes the focus state of an object image by moving a predetermined lens of the imaging optical system 101 using a lens driving unit 1502. The lens control circuit 1406 has an internal arrangement as shown in FIG. 15.

A CPU 1503 is an arithmetic unit which controls the operation of the lens control circuit 1406. The CPU 1503 outputs, to the lens driving unit 1502, a control signal corresponding to lens driving amount information out of input lens driving data to change the position of a predetermined lens of the imaging optical system 101. When a focus adjustment lens (not shown) is moving, the CPU 1503 outputs a signal BSY to the lens communication circuit 1405. When the lens communication circuit 1405 receives this signal, serial communication between the lens communication circuit 1405 and the lens control circuit 1406 is not executed.

A memory 1501 is a nonvolatile memory. The memory 1501 stores, for example, the type of the imaging optical system 101, the positions of the range ring and zoom ring, a coefficient representing the extension amount of the focus adjustment lens with respect to the defocus amount, and exit pupil information corresponding to the focal length of the imaging lens. The exit pupil information is information about the position of a member for restricting the effective f-number for a light beam passing through the imaging optical system 101 or the diameter of the member, such as the imaging lens aperture 304, front frame member 305, or back frame member 306. Information stored in the memory 1501 is read out by the CPU 1503, is applied predetermined arithmetic processing, and is transmitted as the lens information DLC to the central processing circuit 1401 via the lens communication circuit 1405.

When the imaging optical system 101 is an optical system having a plurality of focal lengths, such as a so-called zoom lens, focal length information is the representative value of each range obtained by dividing a continuously changing focal length into a plurality of ranges. In general, range ring position information is not directly used in focusing calculation, and thus its precision need not be so high, unlike other pieces of information.

Upon receiving a control signal CSPC from the central processing circuit 1401, a photometry circuit 1407 outputs an output SSPC of each photometry region of the photometry sensor 111 to the central processing circuit 1401. The output SSPC of each photometry region is A/D-converted by the ADC of the central processing circuit 1401, and used as data for controlling the shutter control circuit 1402 and aperture control circuit 1403. The central processing circuit 1401 detects the ratio of predetermined wavelength light components contained in a light beam passing through the focus detection region by using outputs from the respective photometry regions.

A sensor driving circuit 1408 is connected to the light receiving element arrays 214 of the light receiving unit 206 of the above-described focus detection unit 120. The sensor driving circuit 1408 drives a light receiving element array 214 corresponding to a selected focus detection region 220, and outputs an obtained image signal SSNS to the central processing circuit 1401. More specifically, the sensor driving circuit 1408 receives control signals STR and CK from the central processing circuit 1401. Based on the signals, the sensor driving circuit 1408 transmits control signals φ1, φ2, CL, and SH to the light receiving element array 214 corresponding to the selected focus detection region 220, thereby controlling driving.

(Object Focusing Processing)

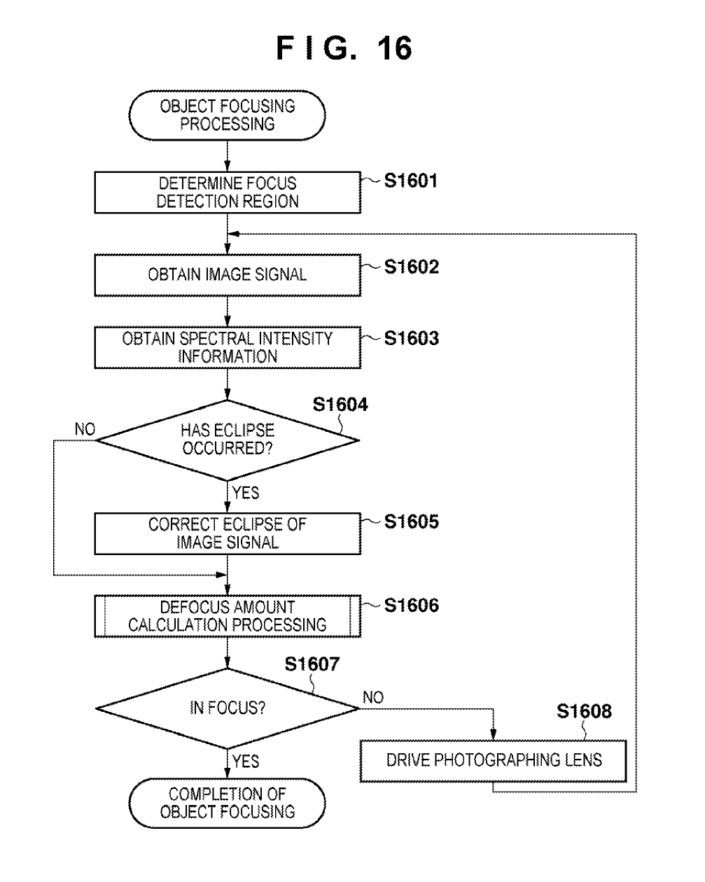

Object focusing processing in the digital camera 100 having the above arrangement according to the embodiment will be explained in detail with reference to the flowchart of FIG. 16. Processing corresponding to this flowchart can be implemented by, for example, reading out a corresponding processing program stored in the ROM, expanding it in the RAM, and executing it by the CPU of the central processing circuit 1401. In the following description, for example, the object focusing processing starts when the user presses a release button (not shown) halfway.

In step S1601, the CPU determines a focus detection region 220, where focus detection is to be performed, out of the predetermined focus detection regions 220 falling within the imaging angle of view. The focus detection region 220 is determined based on a user instruction, a principal object detection algorithm in the digital camera 100, or the like.

In step S1602, the CPU controls the sensor driving circuit 1408 to expose light receiving element arrays 214 corresponding to the focus detection region 220 where focus detection is to be performed that has been determined in step S1601. The exposure time of the light receiving element arrays 214 is determined not to saturate the light quantity in each light receiving element. After the end of exposing the light receiving element arrays 214, the CPU receives the image signals SSNS of the light receiving element arrays 214 from the sensor driving circuit 1408.

In step S1603, the CPU controls the photometry circuit 1407 so that the photometry sensor 111 performs photometry in a photometry region corresponding to the focus detection region 220 where focus detection is to be performed that has been determined in step S1601. Then, the CPU obtains, from the photometry circuit 1407, the output value of the photometry sensor 111 for the photometry region corresponding to the focus detection region 220 where focus detection is to be performed. Further, the CPU obtains the ratio of predetermined wavelength light components contained in a light beam used in focus detection in the photometry region. Note that exposure of the photometry sensor 111 may be executed at a timing synchronized with the focus detection operation in step S1602. Of outputs from the photometry sensor 111 immediately before the focus detection operation, an output from the photometry sensor 111 for the photometry region corresponding to the focus detection region 220 where focus detection is to be performed may be used in the following processing.

In step S1604, the CPU determines whether a light beam used in focus detection in the vertical or horizontal direction is eclipsed in the focus detection region 220 where focus detection is to be performed. As described above, whether the light beam used in focus detection is eclipsed changes depending on the spectral intensity of the light beam, the arrangements and structures of the imaging optical system 101 and focus detection unit 120, and the like. In the embodiment, the CPU makes the determination using a table representing the presence/absence of generation of an eclipse in at least either the vertical or horizontal direction for information about the lens type and focal length that can be obtained from the imaging optical system 101, and for the focus detection region 220.

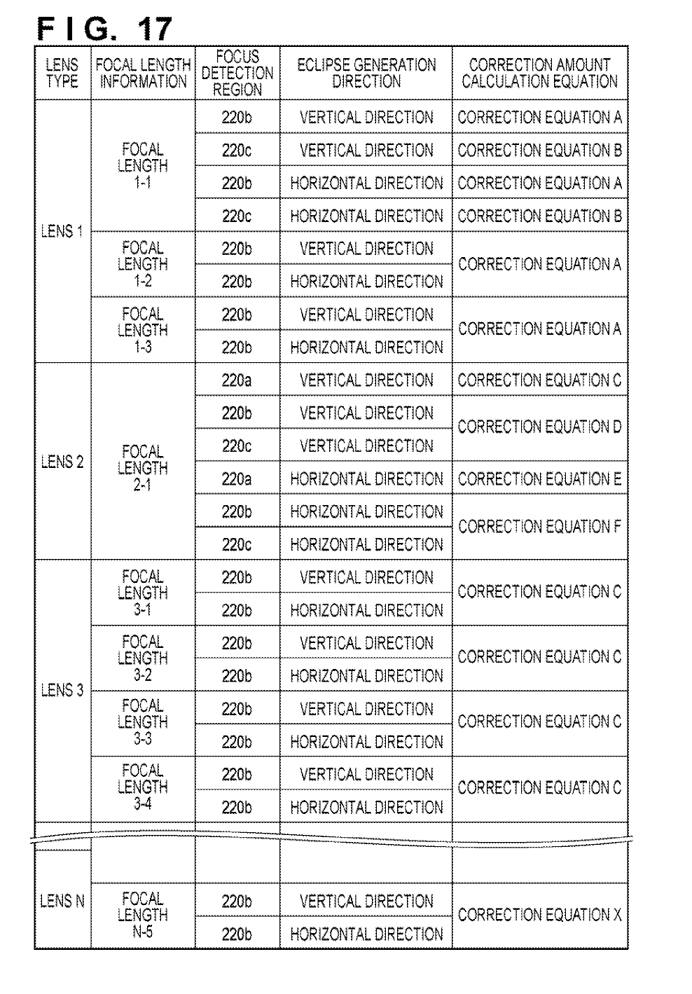

For example, as shown in FIG. 17, the table representing the presence/absence of generation of an eclipse may be configured not to contain a combination for which no eclipse occurs. This table includes a correction equation for correcting an output from a light receiving element array 214 in a direction in which an eclipse occurs, out of the light receiving element arrays 214 corresponding to the focus detection region 220 where focus detection is to be performed.

More specifically, in step S1604, the CPU determines whether the table representing the presence/absence of generation of an eclipse contains a combination (focus detection condition) of the lens type and focal length obtained from the mounted imaging optical system 101, and the focus detection region 220 where focus detection is to be performed. If the table representing the presence/absence of generation of an eclipse contains the focus detection condition, the CPU determines that the light beam used in focus detection is eclipsed, and the process shifts to step S1605. If the table representing the presence/absence of generation of an eclipse does not contain the focus detection condition, the CPU determines that the light beam used in focus detection is not eclipsed, and the process shifts to step S1606.

In step S1605, the CPU corrects outputs from the light receiving element arrays 214 corresponding to the focus detection region 220, where focus detection is to be performed, by using a correction equation which corresponds to the focus detection condition and is obtained from the table representing the presence/absence of generation of an eclipse.

Letting IN(g) be a pixel value input from a pixel g of the light receiving element array 214 and OUT(g) be a pixel value output after correction, the basic form of the correction equation is given by

OUT(g)=IN(g)×(K₁(g)×T₁+K₂(g)×T₂+ . . . +Kₙ(g)×Tₙ)

The correction equation determines the eclipse correction coefficient Kᵢ(g) for each of i (=1, 2, . . . , n) wavelengths for each pixel. The correction coefficients are added at the ratio Tᵢ at which the light beam contains i wavelength light components, thereby obtaining a new correction coefficient for correcting a pixel value. The pixel value is multiplied by the thus-obtained new correction coefficient, obtaining an output in which the influence of an eclipse is corrected by taking account of the spectral intensity. That is, the correction equation for each focus detection condition in the table representing the presence/absence of generation of an eclipse determines, for each light receiving element array 214 corresponding to the focus detection region, the eclipse correction coefficient which changes between respective predetermined wavelengths. Note that the eclipse correction coefficient which changes between respective wavelengths is not limited to a numerical value, and may be a polynomial using, for example, the pixel position as a variable.

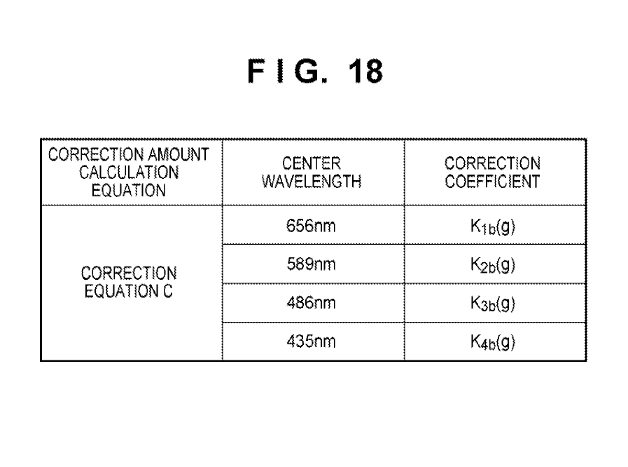

For example, when the mounted imaging optical system 101 is “lens 3”, the currently set focal length is “focal length 3-3”, and the “focus detection region 220b” is selected, the direction in which an eclipse occurs is the vertical direction, and the correction equation used in focus detection is “correction equation C”. For example, correction equation C suffices to determine correction coefficients for respective wavelengths at which the photometry sensor 111 detects the spectral intensity as shown in FIG. 18, for the light receiving element arrays 214b-1 and 214b-2 in the vertical direction out of the light receiving element arrays 214b corresponding to the focus detection region 220b. By using the obtained correction equation, the CPU corrects an output from each light receiving element array 214 of the focus detection region 220 where focus detection is to be performed.

In step S1606, the CPU detects the phase difference by calculating the correlations between outputs from light receiving element arrays paired in the vertical direction and those paired in the horizontal direction out of the light receiving element arrays 214 corresponding to the focus detection region 220 where focus detection is to be performed. Then, the CPU calculates the defocus amount including the defocus direction from the phase difference. Note that calculation of the defocus amount can use a well-known method as disclosed in Japanese Patent Publication No. 5-88445. If an output from the light receiving element array 214 has been corrected in step S1605, the CPU only calculates the defocus amount for the corrected output from the light receiving element array in this step.

In step S1607, the CPU determines, based on the defocus amount calculated in step S1606, whether the object is in focus in the current focus state. If the CPU determines that the object is in focus in the current focus state, the object focusing processing ends; if the CPU determines that the object is out of focus in the current focus state, the process shifts to step S1608. In step S1608, the CPU moves a predetermined lens of the imaging optical system 101 in accordance with the defocus amount, and the process returns to step S1602.

After the object becomes in focus, the digital camera 100 can photograph. When the user presses the release button fully, the digital camera 100 executes imaging processing. If the digital camera 100 waits for a predetermined time without receiving a imaging instruction from the user after the object becomes in focus, the CPU may execute object focusing processing again because the focus detection state may change.

In the embodiment, the spectral intensity of a light beam used in focus detection is measured using the photometry sensor 111. However, the practice of the present invention is not limited to this. For example, the spectral intensity may be measured on the light receiving element array 214. The focus detection method is not limited to the method described in the embodiment, and the present invention can be practiced even using another passive focus detection method. For example, the present invention is effective when phase difference-based focus detection is performed by a pair of pixels arranged on an expected imaging surface 210 of a imaging lens as disclosed in Japanese Patent Laid-Open No. 2000-156823 using light beams passing through different portions of the imaging lens.

In the above-described embodiment, information representing the presence/absence of generation of an eclipse in correspondence with each focus detection condition is stored in the storage area on the body side of the digital camera. However, the information may be stored in the storage area of a lens barrel. With this setting, the present invention can cope with even a lens barrel developed after the manufacture of the digital camera body.

In the above-described embodiment, the table representing the presence/absence of generation of an eclipse contains information about all focus detection regions where an eclipse occurs. However, for focus detection regions which exist at positions symmetrical about the optical axis of the optical system, the table suffices to contain only information about one focus detection region. Also, the method of determining the presence/absence of generation of an eclipse is not limited to a method which looks up the table. The presence/absence of generation of an eclipse may be determined every time using information such as the exit pupil and the positions and diameters of the front and back frame members which are obtained from the lens barrel.

The above-described embodiment has explained a method of correcting the influence of an eclipse on a light receiving element array corresponding to a focus detection region where focus detection is to be performed. However, whether the focus detection region is usable in focus detection may be determined based on the degree of eclipse. More specifically, when it is determined that the influence of an eclipse is significant in an output from the light receiving element array and even correction cannot improve the focus detection precision, the focus detection region can be excluded from the focus detection target, avoiding poor-precision focus detection.

As described above, the image capturing apparatus according to the embodiment can correct an eclipse at high precision by accurately calculating the eclipse amount of a light beam used in focus detection by the imaging optical system without the influence of the object color or the light source in the imaging environment. The image capturing apparatus can perform high-precision focus detection.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-076393, filed Mar. 30, 2011, which is hereby incorporated by reference herein in its entirety.

1. An image capturing apparatus including a detection unit configured to perform passive focus detection using outputs from a pair of light receiving element arrays which receive optical images generated by a pair of light beams having passed through different regions of an exit pupil of an imaging optical system, comprising:
an obtaining unit configured to obtain a ratio of light quantities of predetermined wavelengths contained in a light beam having passed through a focus detection region where focus detection is to be performed by the detection unit;
a determination unit configured to determine whether the light beam is eclipsed due to the imaging optical system; and
a correction unit configured to, when said determination unit determines that the light beam is eclipsed, correct outputs respectively from the pair of light receiving element arrays using new correction coefficients obtained by calculating, in accordance with the ratio, eclipse correction coefficients determined in advance for the respective predetermined wavelengths,
wherein when said determination unit determines that the light beam is eclipsed, the detection unit performs the focus detection using the outputs from the pair of light receiving element arrays that have been corrected by said correction unit.

2. The apparatus according to claim 1, wherein said correction unit obtains the new correction coefficient using the eclipse correction coefficient determined in advance for a combination of a type of the imaging optical system, a focal length currently set in the imaging optical system, and a focus detection region where the focus detection is to be performed.

3. The apparatus according to claim 1, wherein said obtaining unit obtains a ratio of light components of the predetermined wavelengths contained in the light beam by using a light receiving element including color filters having the respective predetermined wavelengths as center wavelengths of transmitted light.

4. The apparatus according to claim 1, wherein in accordance with information which determines in advance for the combination of the type of the imaging optical system, the focal length currently set in the imaging optical system, and the focus detection region where the focus detection is to be performed, said determination unit determines whether the light beam is eclipsed.

5. The apparatus according to claim 1, wherein by using the exit pupil of the imaging optical system, and positions and diameters of a front frame member and back frame member of the imaging optical system on an optical axis, said determination unit determines whether the light beam is eclipsed.

6. A method of controlling an image capturing apparatus including a detection unit configured to perform passive focus detection using outputs from a pair of light receiving element arrays which receive optical images generated by a pair of light beams having passed through different regions of an exit pupil of an imaging optical system, comprising:
an obtaining step of obtaining a ratio of light quantities of predetermined wavelengths contained in a light beam having passed through a focus detection region where focus detection is to be performed by the detection unit;
a determination step of determining whether the light beam is eclipsed due to the imaging optical system; and
a correction step of correcting outputs respectively from the pair of light receiving element arrays using new correction coefficients obtained by calculating, in accordance with the ratio, eclipse correction coefficients determined in advance for the respective predetermined wavelengths when the light beam is determined in the determination step to be eclipsed,
wherein when the light beam is determined in the determination step to be eclipsed, the detection unit performs the focus detection using the outputs from the pair of light receiving element arrays that have been corrected in the correction step.

7. A computer-readable storage medium storing a program for causing a computer of an image capturing apparatus to function as each unit of the image capturing apparatus defined in claim 1.
